(19) United States
(12) Patent Application Publication
(10) Pub. No.: US 2021/0209647 A1
(43) Pub. Date: Jul. 8, 2021

(54) IN-VEHICLE CONTEXTUAL PROMOTIONS

(71) Applicant: Sirius XM Connected Vehicle Services Inc, Irving, TX (US)

(72) Inventors: William Mitchell Dornich, Copper Canyon, TX (US); John Jasper, Lantana, TX (US); Paul Doucette, Allen, TX (US); Victoria Repice, Southlake, TX (US); Marti Gold, Allen, TX (US)

(21) Appl. No.: 17/143,136

(22) Filed: Jan. 6, 2021

Related U.S. Application Data
(60) Provisional application No. 62/957,711, filed on Jan. 6, 2020.

(51) Int. Cl. G06Q 30/02; G06Q 20/36

(52) U.S. Cl. CPC G06Q 30/0265; G06Q 20/367

(57) ABSTRACT

Methods and a system for in-vehicle contextual promotions are described herein. In a first method a driver receives in-vehicle promotions on a predetermined route and user-defined favorite vendors. The driver taps on the promotion and receives a list of favorite items. The driver makes a selection of one of the favorite items, makes a payment for the selected product using an e-wallet, and picks up the selected product. The driver may also receive loyalty rewards. In a second method, the driver may receive an in-vehicle promotion, including a “remind me later” link. When the user taps on the link, they may access the promotion at a later time on the user's mobile phone app. The user taps on the saved link and is redirected to a vendor's website. The user may make a purchase for a product at the vendor's website at this later time.

### CROSS REFERENCE TO RELATED APPLICATIONS

This application claims the benefit of U.S. Provisional Application No. 62/957,711, filed Jan. 6, 2020, the contents of which are hereby incorporated by reference herein.

### FIELD OF INVENTION

This application is in the field of in-vehicle services.

### SUMMARY

Methods and a system for in-vehicle contextual promotions are described herein. In a first method, a driver may receive an in-vehicle promotion for businesses along a driving route. In a second method, a driver may be able to transmit a reminder, to the driver's mobile phone, to visit an as advertised website at a time after the driver is out of the vehicle.

In a first example method, a driver may receive an in-vehicle promotion, wherein the promotion is based on a driver's route and driver-defined favorite vendors. The driver may then tap on the in-vehicle promotion and receive a list of menu items. For example, the menu items may include a list of the driver's favorite or recently ordered items. The driver may then make a selection of at least one of the favorite items. The driver may then make a payment for the product selection using an e-wallet and pick up the selected product. Additionally, the driver may receive loyalty rewards for their in-vehicle purchase.

In a second example method, the user may receive an in-vehicle promotion, wherein the promotion includes the “remind me later” link. The user may then tap on the “remind me later” link. At a later time, the user may access a Marketplace in a user's phone app. The user may tap on at least one of the “remind me later” links and is then redirected to a vendor's website. The user may then make a purchase for a product at the vendor's website.

The system may be coupled to in-vehicle media, for example, 360L.

The system may be integrated with a navigation system to facilitate a better and safer driving experience for in-car offers.

The system may leverage voice as part of the experience to minimize distracted driving and create a better user experience

The system may support direct service types such as fuel, parking and food. Additionally, the system may support a wide range of other services such as Original Equipment Manufacturer (OEM) services or a push to “remind later” services that might be related to an audio advertisement which the audio system presents (for example, Boll and Branch).

### BRIEF DESCRIPTION OF THE DRAWINGS

FIG. 1 is an example of an in-vehicle contextual alert;

FIG. 2 is an example of an order overlay;

FIG. 3 is an example vendor order screen;

FIG. 4 is an example of an e-wallet screen with the driver's payment options;

FIG. 5 is an example of payment confirmation and route update screen;

FIG. 6 is an example of an arrival screen;

FIG. 7 is an example of a thank you and loyalty program screen;

FIG. 8 is an example method of receiving and utilizing in-vehicle promotions;

FIG. 9 is an example of a “send a reminder to my phone” link;

FIG. 10 is an example screen illustrating that a reminder has been successfully sent;

FIG. 11 is an example home page of the mobile phone app with Marketplace reminder alerts;

FIG. 12 is an example of Marketplace reminders;

FIG. 13 is an example screen of successfully navigating to a vendor's mobile website; and

FIG. 14 is an example method of receiving an in-vehicle promotion including a “remind me later” link.

### DETAILED DESCRIPTION OF THE DRAWINGS

Methods and a system for in-vehicle contextual promotions are described herein. In a first method, a driver may receive an in-vehicle promotion for businesses along a driving route. In a second method, a driver may be able to transmit a reminder, to the driver's mobile phone, to visit an as advertised website at a time after the driver is out of the vehicle.

In a first embodiment, a user, or driver, may activate the navigation system of a vehicle and enter a particular destination. When the navigation system is activated, a cloud system may run a search and pull coordinates for all user-defined favorites and loyalty linked vendors along the selected route. For example, user-defined favorites and loyalty linked vendors may include both food and beverage vendors, such as Starbucks, Panera, and the like.

Each vendor may have a predefined proximity range. For example, when a driver is within a 10 mile radius of a participating vendor. Once the driver's vehicle reaches the predefined proximity range, the radio may resend a target message. The vendor may use the radio to present the message to the driver, in context and unobtrusively, as the driver approaches a favorite store or destination along their route.

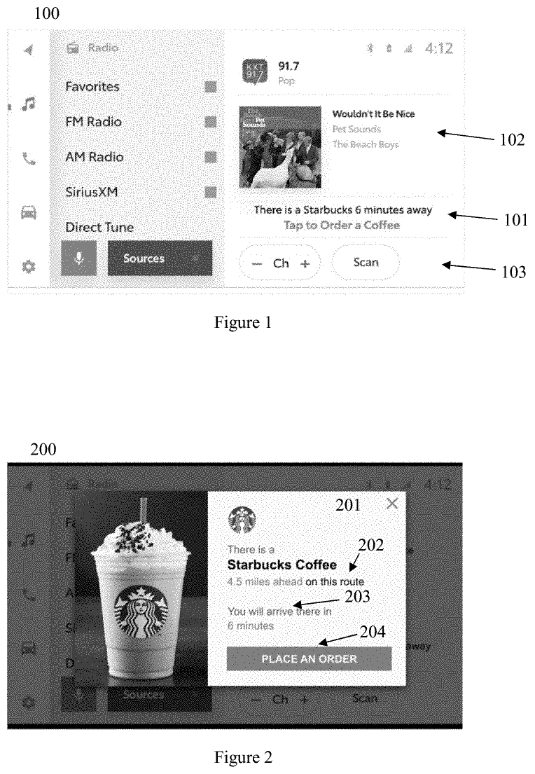

FIG. 1 is an example of an in-vehicle contextual alert. The contextual alert 101 may identify that a Starbucks is 6 minutes away. The contextual alert 101 may be shown as a message just below the song information 102 and just above the radio options 103. As illustrated in FIG. 1, the contextual alert 101 does not interfere with the other information on the radio screen 100.

On a condition that the user taps the contextual alert, the radio may display an overlay that contains information for the vendor. For example, the information may include time and distance to reach the vendor, a promotional offer, an option to order, and the like.

FIG. 2 is an example of an order overlay. The order overlay 201 may appear over the radio screen 200. The order overlay 201 may identify that there is, for example, a Starbucks Coffee 4.5 miles ahead 202 on the route the driver is traveling. The order overlay 201 may further indicate that it takes 6 minutes to arrive 203. The order overlay 201 may allow a driver to place an order by pressing the place an order button 204.

The driver may then be taken directly to the vendor's order screen. The default view may be the driver's favorite items or the most recently ordered items from that vendor. Alternatively, if the driver is interested in a different item than their favorites or most recently ordered, the vendor's full menu may also be easily accessible.

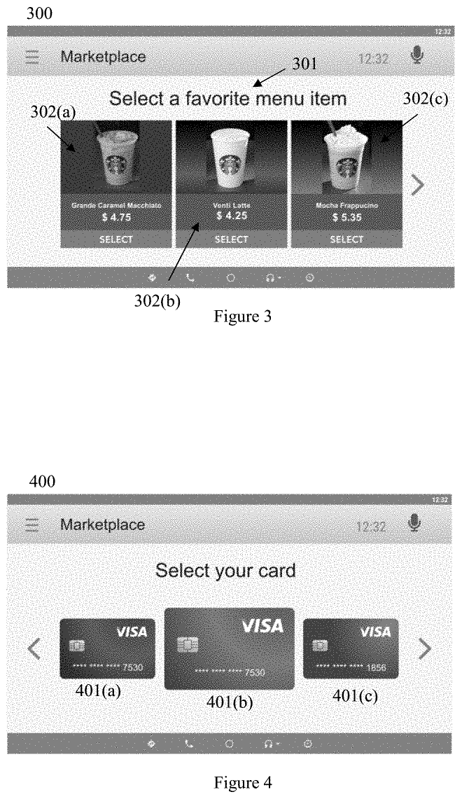

FIG. 3 is an example vendor order screen. The vendor order screen 300 includes a driver's favorite menu items 301. Once the driver presses the place an order button (203 in FIG. 2), a menu 301 of the user's favorite items may open. The driver may then easily select an option 302(a), 302(b), or 302(c) for ordering.

Once the driver makes a selection, the driver may then access their electronic wallet (or e-wallet), based on the vehicle. For example, access to the driver's wallet may include a personal identification number (PIN), touch, biometrics, or any other convenient method. Active credit cards may be visually prominent.

FIG. 4 is an example of an e-wallet screen with the driver's payment options. The driver may be prompted to select a card 401(a), 401(b), or 401(c), from the driver's e-wallet screen 400. The driver may then confirm payment.

Once the driver confirms payment, the screen may then display the user's order confirmation with receipt information. The screen may also display any minor navigation updates to reach the location of the vendor.

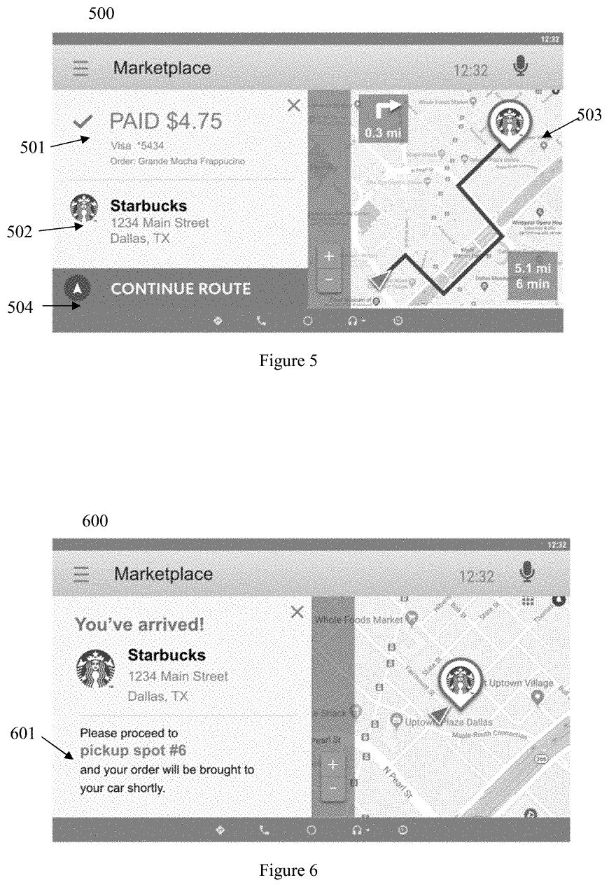

FIG. 5 is an example of a payment confirmation and route update screen. The payment confirmation and route update screen 500 may include a paid receipt 501, a store name and address, 502, and a route update 503 for reaching the desired location. The driver may select the continue route button 504 to follow the suggest route update 503.

As the car approaches the vendor, a message, for example, “you've arrived,” may be displayed with instructions on how to pick up the user's order. The message may appear once a geo-fence of the vendor is broken by the driver's car. This may also serve as an indication to the vendor that the driver has arrived to retrieve their order.

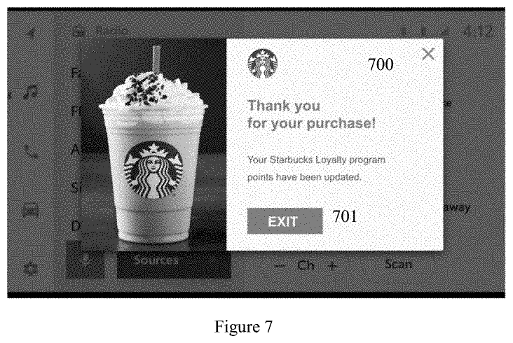

FIG. 6 is an example of an arrival screen. The arrival screen 600 may include details for where the drive should park their car for pickup services 601.

After the driver picks up their order, all transaction data (for example, timestamp, vendor name and location, item information, price, and the like) may be transmitted to the Original Equipment Manufacturer's (OEM's) Marketplace database or cloud for reconciliation. Once the order is completed, for example, the order has been received, information about the transaction may be sent to the respective loyalty program and the driver is alerted.

FIG. 7 is an example of a thank you and loyalty program screen. A pop-up 700 may appear on the screen to thank the driver for their purchase. The pop-up screen may also indicate that the driver has received loyalty points for their purchase. The driver may then press exit 701 to return to the original radio screen.

The system described herein may ensure that drivers receive and use valuable loyalty program points and discounts. The system may also provide drivers with the ability to instantly sign up for new loyalty programs from a head unit or from within the SiriusXM app.

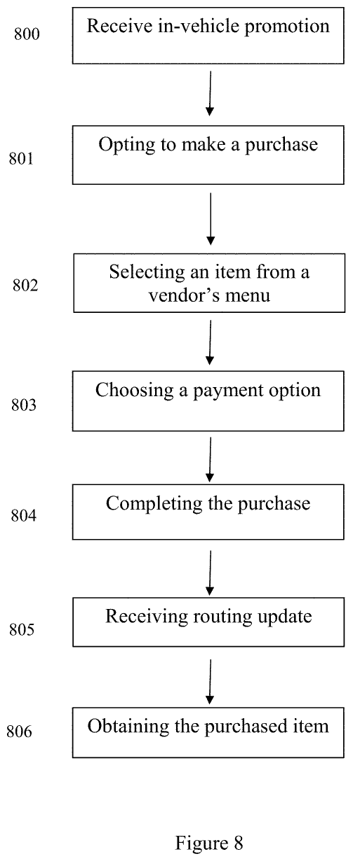

FIG. 8 is an example method of receiving and utilizing in-vehicle promotions. A driver may receive an in-vehicle promotion from a vendor along a predetermined route 800. The driver may then choose to make a purchase based on the received promotion 801. On a condition that the driver chooses to make a purchase, a menu screen appears. The menu screen may include the driver's favorite or recently purchased items. The driver may then make a selection from the menu screen 802. Once the driver makes a selection, an e-wallet screen appears. The driver may select from one of several credit cards in the e-wallet 803. Once the driver has selected a credit card, the driver may then receive a paid confirmation 804 and routing instructions 805. After the driver has passed through a geo-fence of the vendor, instructions for pickup services will appear. Once the driver has received their desired item 806, a pop-up may appear to thank the driver for their purchase. On a condition that the desired vendor has a loyalty rewards program, the driver's account may be updated with any loyalty rewards.

In a second embodiment, vendors participating in an OEM Marketplace may display a “send a reminder to my phone” link in addition to normally shown advertisement information on a radio screen. For example, normally shown advertisement information may include a vendors name and website.

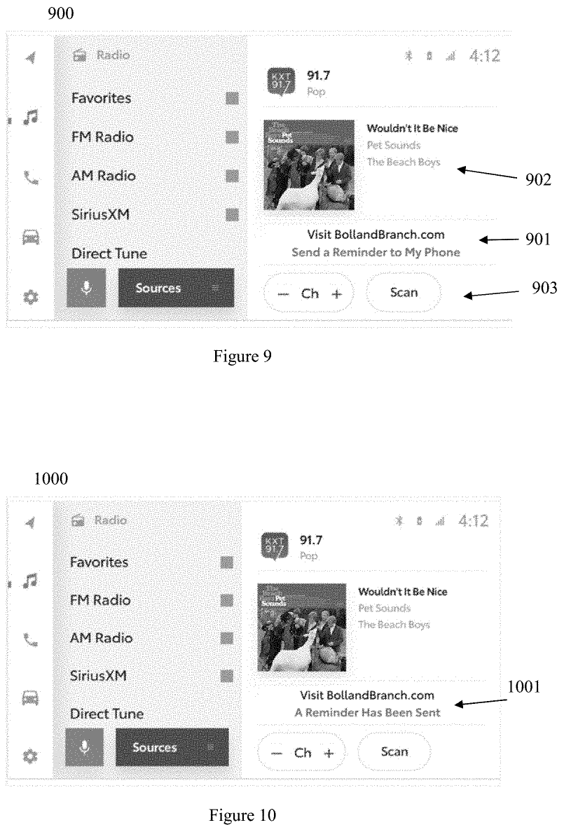

FIG. 9 is an example of a “send a reminder to my phone” link. A “send a reminder to my phone” link 901 may appear on a radio screen 900 as a reminder for a driver to go to an advertised website, for example, visit BollandBranch.com, at a later time. The “send a reminder to my phone” link 901 may be shown as a message just below the song information 902 and just above the radio options 903. As shown in FIG. 9, the “send a reminder to my phone” link 901 does not interfere with the other information on the radio screen 900.

The driver may then tap the “send reminder to my phone” link. When the message is tapped, the system may send all relevant driver and advertiser information to the driver's OEM Owner's account. This information will appear the next time the driver logs into their mobile application.

FIG. 10 is an example of a message illustrating that a reminder has been successfully sent. The radio screen 1000 may now show that a reminder has been sent 1001.

At some time later, after the driver has exited the vehicle, the driver may log into a mobile phone app, for example the SiriusXM app. The driver may see links and alerts for Marketplace (in addition to the vehicle status and service sections) in the mobile phone app.

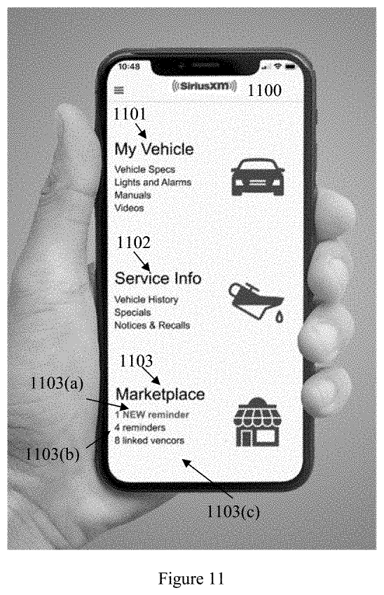

FIG. 11 is an example home page of the mobile phone app with Marketplace reminder alerts. The home page of the mobile phone app 1100 may include a my vehicle section 1101, a service info section 1102, and a marketplace section 1103. In the marketplace section 1103, the user may notice at least 1 new reminder 1103(a), other reminders 1103(b), and linked vendors 1103(c).

The user may then tap the Marketplace reminders. Once the Marketplace reminders are open, the driver may see a scrollable list of all saved reminders. Each time the driver taps the “send me a reminder” link, the vendor and timestamp information is sent to the reminder list. This may permit the driver to access any saved vendor and safely make a purchase.

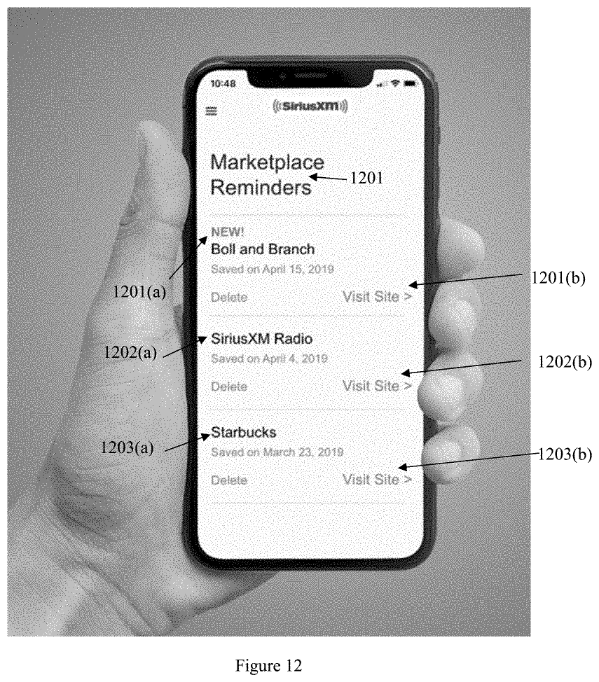

FIG. 12 is an example of Marketplace reminders. The marketplace reminders 1201 may include the new reminder 1201(a), for example, for Boll and Branch, and a link to visit the website 1201(b). The marketplace reminders 1101 may also include older reminders 1202(a) and 1203(a), for example, Sirius XM Radio and Starbucks, and a link to visit those websites 1202(b) and 1203(b).

Once the user clicks on the appropriate link, the user is taken to the vendor's mobile website to safely make purchases. The Marketplace system may add tags to the Uniform Resource Locator (URL) ensuring accurate tracking and revenue credits.

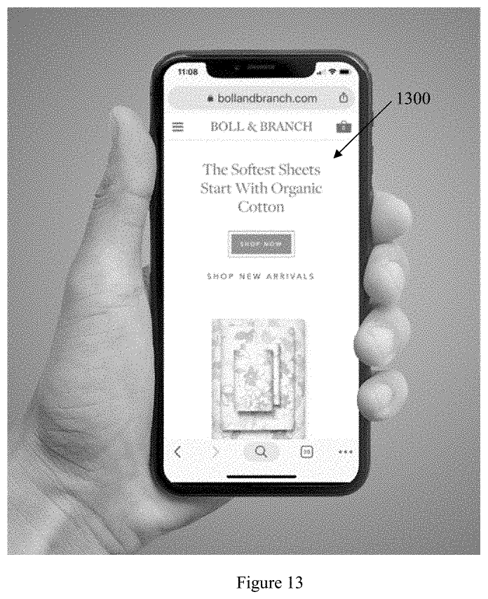

FIG. 13 is an example screen of successfully navigating to a vendor's mobile website. The vendor's mobile website 1300 may appear on the user's mobile phone in response to clicking the visit site button (1201(a) shown in FIG. 12).

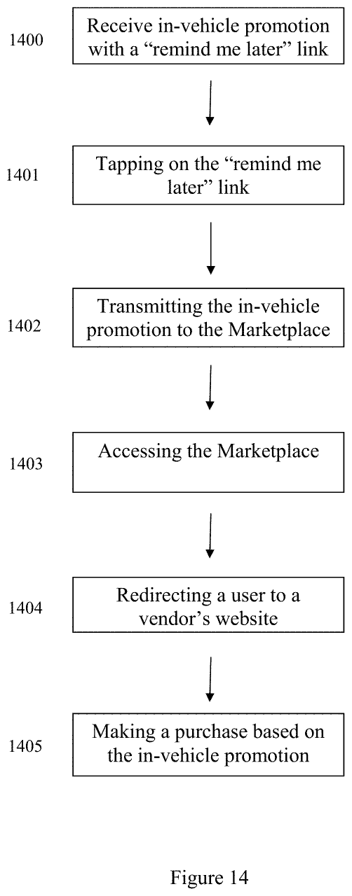

FIG. 14 is an example method of receiving an in-vehicle promotion including a “remind me later” link. The user may receive an in-vehicle promotion including a “remind me later” link from a vendor participating in a Marketplace 1400. The user may then tap on the “remind me later” link 1401. By clicking this link, the in-vehicle promotion is transmitted to the Marketplace 1402. At a later time, the user may access the Marketplace of a phone app of the user 1403. The user may tap on at least one of the “remind me later” links and is then redirected to a vendor's website 1404. The user may then make a purchase for a product at the vendor's website based on the received in-vehicle promotion 1405.

What is claimed:

1. A method for making in-vehicle purchases from received contextual promotions, the method comprising:
receiving an in-vehicle promotion;
opting to make a purchase based on the received in-vehicle promotion;
selecting at least one item for purchase from a vendor;
making a payment for the at least one item using an e-wallet;
receiving a routing update to a location of the vendor; and
picking up the at least one purchased item at the location of the vendor.

2. The method of claim 1, wherein the in-vehicle promotion is based a driver's route.

3. The method of claim 1, wherein the in-vehicle promotion is based on user-defined favorite vendors.

4. The method of claim 1, wherein the at least one item for purchase is selected from a list of favorite items.

5. The method of claim 1, wherein access to the e-wallet requires at least one of a personal identification number (PIN), touch, and biometrics.

6. The method of claim 1, further comprising:
receiving an arrival message as the vehicle approaches the location of the vendor.

7. The method of claim 6, wherein the arrival message is received once a geo-fence of the vendor is broken.

8. The method of claim 1, further comprising:
receiving loyalty rewards.

9. The method of claim 1, wherein the vendor is a user-defined favorite vendor.

10. A method for receiving an in-vehicle promotion including a “remind me later” link, the method comprising:
receiving at least one in-vehicle promotion with a “remind me later” link from a vendor, wherein the vendor participates in a Marketplace;
tapping on the “remind me later” link;
transmitting the at least one in-vehicle promotion to the Marketplace of a mobile phone app of a user;
accessing the at least one in-vehicle promotion in the Marketplace; and
making a purchase for a product at a vendor's website based on the at least one received in-vehicle promotion.

11. The method of claim 10, wherein the Marketplace of the mobile phone app stores all “remind me later” links.

12. The method of claim 10, wherein the at least one “remind me later” link include vendor and timestamp information.

13. The method of claim 10, wherein the Marketplace adds tags to the Uniform Resource Locator (URL) to ensure accurate tracking and revenue credit.
